(19) United States
(12) Patent Application Publication
(10) Pub. No.: US 2019/0075617 A1
(43) Pub. Date: Mar. 7, 2019

(54) CONTROL STATION APPARATUS, COMMUNICATION METHOD, AND COMMUNICATION SYSTEM

(71) Applicant: SHARP KABUSHIKI KAISHA, Sakai City, Osaka (JP)

(72) Inventors: HIROMICHI TOMEBA, Sakai City (JP); HIDEO NAMBA, Sakai City (JP); YASUHIRO HAMAGUCHI, Sakai City (JP)

(21) Appl. No.: 16/080,432

(22) PCT Filed: Feb. 22, 2017
(86) PCT No.: PCT/JP2017/006490

§ 371 Date: Aug. 28, 2018

(30) Foreign Application Priority Data
Mar. 2, 2016 (JP) 2016-039736

(51) Int. Cl. H04W 88/12; H04W 88/16; H04W 76/14

(52) U.S. Cl. CPC H04W 88/12; H04W 92/12; H04W 76/14; H04W 88/16

(57) ABSTRACT

Provided are a control station apparatus, a communication method, and a communication system that enable a radio access network that is capable of flexibly adapting to various required conditions. A control station apparatus according to an embodiment of the present invention includes a function for communicating with a base station apparatus and a communication apparatus, a function for transferring data received from the communication apparatus to the base station apparatus, and a function for transferring data received from the base station apparatus to the communication apparatus, and the control station apparatus efficiently selects a communication method used in a case of communicating with the base station apparatus, and a communication method used in a case of communicating with the communication apparatus.

### TECHNICAL FIELD

The present invention relates to a control station apparatus, a communication method, and a communication system.

### BACKGROUND ART

With a goal of launching commercial services from around 2020, research and development activities for the 5th generation mobile radio communication system (5G system) have been actively conducted. Recently, International Telecommunication Union Radio communications Sector (ITU-R) as an international standardization organization has reported a vision recommendation for a standard scheme of the 5G system (International mobile telecommunication—2020 and beyond: IMT-2020) (see NPL 1).

In the vision recommendation, various use cases in which the 5G system provides communication services are classified into three major use scenarios (Enhanced mobile broadband (EMBB), Enhanced Massive machine type communication (eMTC), Ultra-reliable and low latency communication (URLLC)). Further, the vision recommendation proposes, as required conditions (Capabilities) of the 5G system, eight indices (Peak data rate, User experienced data rate, Spectrum efficiency, Mobility, Latency, Connection density, Network energy efficiency, Area traffic capacity), and respective target values. However, since the 5G system is expected to support enormous use cases/use scenarios that have different required conditions respectively, the vision recommendation also points out that the 5G system is not required to satisfy all the above required conditions simultaneously, and that it is sufficient for the 5G system to satisfy required conditions for each use scenario. This suggests that radio performance provided by a radio access network (RAN) included in the 5G system is required to change dynamically momentarily.

As a mode of the RAN capable of flexibly controlling the provided radio performance, a Heterogeneous network (HetNet) has been studied. In the HetNet, unlike a Homogeneous network (HomoNet) in which a traditional base station apparatus centrally manages the whole network, multiple subnetworks are constituted in a network, and radio communication will be controlled not only for the whole network as before but also for each subnetwork. The HetNet including the multiple subnetworks that have different radio network performance respectively is expected to enable a RAN capable of flexibly controlling radio performance.

### CITATION LIST

### Non Patent Literature

NPL 1: “IMT Vision—Framework and overall objectives of the future development of IMT for 2020 and beyond,” Recommendation ITU-R M.2083-0, September 2015.

### SUMMARY OF INVENTION

### Technical Problem

According to a traditional concept of the HetNet, as a method for radio resource control for each subnetwork, a method in which a control apparatus in a subnetwork controls autonomously and in a distributed manner and a method in which a base station apparatus controls centrally have been studied. However, in the case that the control apparatus controls autonomously and in a distributed manner, the control apparatus is capable of grasping only a situation around own device, and thus is not always capable of performing optimal radio resource control. Meanwhile, in the case that the base station apparatus controls centrally, as the number of subnetworks included in the HetNet increases, an amount of control information becomes enormous, thus it is unrealistic to control all the subnetworks included in the HetNet.

The present invention is made in view of the above-described circumstances, an objective thereof is to provide a control station apparatus, a communication method, and a communication system for enabling a radio access network capable of flexibly adapting to various required conditions, using a heterogeneous network including a flexible communication control scheme.

### Solution to Problem

To address the above-mentioned drawbacks, a control station apparatus, a communication method, and a communication system according to an aspect of the present invention are constituted as follows.

(1) That is, a control station apparatus according to an aspect of the present invention is a control station apparatus that at least includes a first communicator configured to communicate as a terminal with a base station apparatus, a second communicator configured to communicate with a first communication apparatus with at least two communication methods, a controller configured to select one communication method from the at least two communication methods, a first data transfer unit configured to transmit data transmitted from the first communication apparatus to the base station apparatus, and a second data transfer unit configured to transmit data transmitted from the base station apparatus to the first communication apparatus, in which, due to a first data transfer by the first data transfer unit from the first communication apparatus to the base station apparatus, in a second data transfer from the base station apparatus to the first communication apparatus performed in the second data transfer unit, the controller selects a communication method different from a communication method used for the first data transfer, or selects an identical communication method to a communication method used for the first data transfer in some cases, and the second data transfer is performed using the selected communication method.

(2) Further, a control station apparatus according to an aspect of the present invention is the control station apparatus described in (1), in which the second communicator further includes a third data transfer unit configured to communicate with a second communication apparatus and transmit data transmitted from the second communication apparatus to the first communication apparatus, the controller, in a third data transfer from the second communication apparatus to the first communication apparatus performed in the third data transfer unit, selects a communication method different from a communication method used for data transfer from the second communication apparatus to own device, or selects an identical communication method to a communication method used for data transfer from the second communication apparatus to own device in some cases, and the third data transfer is performed using the selected communication method.

(3) Further, a control station apparatus according to an aspect of the present invention is the control station apparatus described in (1), that further includes a third data transfer unit configured to transmit data transmitted from the first communication apparatus to the first communication apparatus again, the controller, in a third data transfer performed in the third data transfer unit in which data transmitted from the first communication apparatus is transmitted to the first communication apparatus again, selects a communication method different from a communication method used for data transfer from the first communication apparatus to own device, or selects an identical communication method to a communication method used for data transfer from the first communication apparatus to own device in some cases, and the third data transfer is performed using the selected communication method.

(4) Further, a control station apparatus according to an aspect of the present invention is the control station apparatus described in any one of (1) to (3), in which the first communicator includes at least two communication methods, and the at least one communication method is capable of transmitting data to an external network.

(5) Further, a control station apparatus according to an aspect of the present invention is the control station apparatus described in (1), that further includes a third communicator configured to communicate with another of the control station apparatus, and a third data transfer unit configured to transmit data transmitted from the first communication apparatus to another of the control station apparatus.

(6) Further, a control station apparatus according to an aspect of the present invention is the control station apparatus described in (5), in which the third data transfer unit transmits data transmitted from the base station apparatus to another of the control station apparatus.

(7) Further, a communication method according to an aspect of the present invention is a communication method included in a control station apparatus, the method at least including the steps of performing a first communication to communicate as a terminal with a base station apparatus, performing a second communication to communicate with a first communication apparatus with at least two communication methods, performing control to select one communication method from the at least two communication methods, performing a first data transfer to transmit data transmitted from the first communication apparatus to the base station apparatus, and performing a second data transfer to transmit data transmitted from the base station apparatus to the first communication apparatus, in which, due to a first data transfer by the performing the first data transfer from the first communication apparatus to the base station apparatus, in a second data transfer from the base station apparatus to the first communication apparatus performed in the step for performing a second data transfer, the performing control selects a communication method different from a communication method used for the first data transfer, or selects an identical communication method to a communication method used for the first data transfer in some cases, and performing the second data transfer using the selected communication method is included.

(8) Further, a communication system according to an aspect of the present invention is a communication system including a base station apparatus, a first communication apparatus and a control station apparatus, the control station apparatus at least including a first communicator configured to communicate as a terminal with the base station apparatus, a second communicator configured to communicate with a first communication apparatus with at least two communication methods, a controller configured to select one communication method from the at least two communication methods, a first data transfer unit configured to transmit data transmitted from the first communication apparatus to the base station apparatus, and a second data transfer unit configured to transmit data transmitted from the base station apparatus to the first communication apparatus, in which, due to a first data transfer by the first data transfer unit from the first communication apparatus to the base station apparatus, in a second data transfer from the base station apparatus to the first communication apparatus performed in the second data transfer unit, the controller selects a communication method different from a communication method used for the first data transfer, or selects an identical communication method to a communication method used for the first data transfer in some cases, and the second data transfer is performed using the selected communication method.

### Advantageous Effects of Invention

According to an aspect of the present invention, a heterogeneous network enabling flexible communication control is provided, thereby making it possible to efficiently provide communication services to various use cases and use scenarios having different required conditions.

### BRIEF DESCRIPTION OF DRAWINGS

FIG. 1 is a diagram illustrating an example of a communication system according to an embodiment of the present invention.

FIG. 2 is a block diagram illustrating an example of a constitution of a control station apparatus according to an embodiment of the present invention.

FIG. 3 is a sequence chart illustrating an example of communication according to an embodiment of the present invention.

FIG. 4 is a diagram illustrating an example of a communication system according to an embodiment of the present invention.

FIG. 5 is a block diagram illustrating an example of a constitution of a control station apparatus according to an embodiment of the present invention.

FIG. 6 is a sequence chart illustrating an example of communication according to an embodiment of the present invention.

FIG. 7 is a diagram illustrating an example of a communication system according to an embodiment of the present invention.

FIG. 8 is a sequence chart illustrating an example of communication according to an embodiment of the present invention.

FIG. 9 is a diagram illustrating an example of a communication system according to an embodiment of the present invention.

FIG. 10 is a block diagram illustrating an example of a constitution of a control station apparatus according to an embodiment of the present invention.

FIG. 11 is a sequence chart illustrating an example of communication according to an embodiment of the present invention.

### DESCRIPTION OF EMBODIMENTS

A communication system according to the present embodiment includes a base station apparatus (a transmission unit, a cell, a transmission point, a group of transmit antennas, a group of transmit antenna ports, a component carrier, eNodeB, an access point, AP, a wireless router, a relay, a communication apparatus), a control station apparatus (a control terminal, a control center, a radio subnetwork controller, a relay device, a relay unit, a relay point, a group of relay antennas, a group of relay antenna ports, a relay node), and a terminal apparatus (a terminal, a mobile terminal, a reception point, a reception terminal, a reception device, a group of receive antennas, a group of receive antenna ports, UE, a station, STA, a communication apparatus).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### 1. First Embodiment

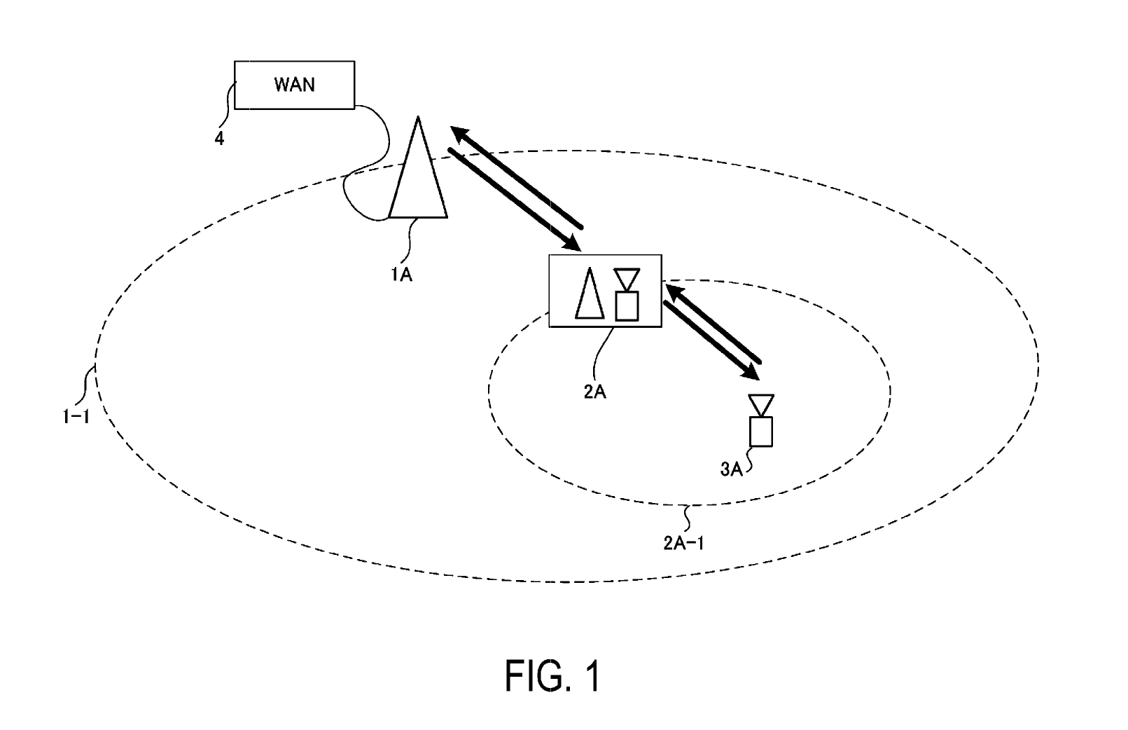

FIG. 1 is a diagram illustrating an example of a communication system according to the present embodiment. As illustrated in FIG. 1, the communication system according to the present embodiment includes a base station apparatus 1A, a control station apparatus 2A, and a terminal apparatus 3A (first communication apparatus). Coverage 1-1 and coverage 2A-1 are ranges (communication areas) in which the base station apparatus 1A and the control station apparatus 2A are able to connect with other devices. Note that, the communication system according to the present embodiment is capable of including multiple base station apparatuses (base station apparatuses 1B, 1C, . . . ), multiple control station apparatuses (control station apparatuses 2B, 2C, . . . ), and multiple terminal apparatuses (terminal apparatuses 3B, 3C, . . . ). Hereinafter, the above-described apparatuses and devices are also simply collectively referred to as a base station apparatus 1, a control station apparatus 2, and a terminal apparatus 3.

In FIG. 1, the base station apparatus 1A is connected with an external network 4 (Wide area network (WAN) in this illustration). The base station apparatus 1A is capable of being mutually connected with a content server providing contents (a service, an application) to devices included in a communication system, via the external network 4.

The base station apparatus 1A has a function for providing devices present in the coverage 1-1 with communication services (data transfer, telephone call, content delivery, broadcasting). For example, the communication services include a cellular service. It is possible to provide the cellular service based on a communication method based on international standards satisfying required conditions recommended by Wireless Communication Division of International Telecommunication Union. For example, the base station apparatus 1A includes a function for providing communication services based on Long Term Evolution (LTE). In this case, the base station apparatus 1A, for example, is capable of providing radio communication from another device to the base station apparatus 1A, using physical channels such as a Physical Uplink Control CHannel (PUCCH), a Physical Uplink Shared CHannel (PUSCH), and a Physical Random Access CHannel (PRACH).

Additionally, the base station apparatus 1A is capable of providing radio communication from the base station apparatus 1A to another device, using physical channels such as a Physical Broadcast CHannel (broadcast channel; PBCH), a Physical Control Format Indicator CHannel (control format indicator channel; PCFICH), a Physical Hybrid automatic repeat request Indicator CHannel (HARQ indicator channel; PHICH), a Physical Downlink Control CHannel (downlink control channel; PDCCH), an Enhanced Physical Downlink Control CHannel (enhanced downlink control channel; EPDCCH), and a Physical Downlink Shared CHannel (downlink shared channel; PDSCH).

The base station apparatus 1A is capable of providing a terminal apparatus connected with own apparatus with a physical cell identity (PCI, cell ID) for identifying own apparatus. The terminal apparatus is capable of communicating with the base station apparatus 1A based on control by the base station apparatus 1A identified by the above physical cell identity.

Hereinafter, a communication method in which the base station apparatus 1A provides communication services is also referred to as a higher communication method.

Note that, a way of distinguishing (defining) communication methods is not limited specifically. For example, it is possible to distinguish communication methods according to the present embodiment by different Radio Access Techniques (RAT) included in the respective communication methods.

The RAT includes wide area access technology represented by a second generation mobile communication system (2G) represented by a global system for mobile communications (GSM; trade name) and Personal Digital Cellular (PDC), a third generation mobile communication system (3G, 3.5G, 3.9G) defined in IMT-2000, a fourth generation mobile communication system (4G) defined in IMT-Advanced, and a fifth generation mobile communication system (5G) defined in “IMT-2020 and beyond”. In addition, the radio access technique includes Wireless local area network (wireless LAN) technology defined in IEEE802.11 standard. Further, the radio access technique includes a short distance radio access technique defined in IEEE802.15 standard and the like. Additionally, the radio access technique includes a radio access technique used by a specific low power radio station.

Further, even communication methods having an identical radio access technique are capable of being defined as different communication methods, in a case that each of the communication methods uses a different radio resource (time, frequency, space).

Further, even communication methods having an identical radio access technique are capable of being defined as different communication methods, in a case that each of the communication methods uses a different radio access mode (an uplink/downlink access mode in which a base station apparatus and a terminal apparatus directly communicate, and a sidelink access mode (Device-to Device (D2D) communication mode) in which terminal apparatuses directly communicate with each other).

Additionally, communication methods using respective different device parameters (the number of antennas, antenna performance (a shape, a gain, directivity), Radio frequency (RF) circuit performance (amplifying performance, filtering performance)) are capable of being defined as different communication methods.

In addition, each of communication methods defined as different communication methods is capable of using a frequency band referred to as a so-called licensed band for which a radio operator obtained a license from a country or region in which the operator serves, a frequency band referred to as a so-called unlicensed band that does not require a license from a country or a region, a frequency band referred to as a white band that is not actually used for the purpose of preventing interference among frequencies even in a case that a license for a specific service is given by a country or a region (for example, a frequency band allocated for TV broadcasting but not used depending on regions), a shared frequency band not allocated exclusively for a specific operator, but shared among multiple operators, and the like.

The base station apparatus 1A is capable of containing the control station apparatus 2A using the higher communication method. The base station apparatus 1A at least partially controls communication performed by the control station apparatus 2A using the higher communication method. Accordingly, the base station apparatus 1A recognizes the control station apparatus 2A as a terminal apparatus controlled by own apparatus.

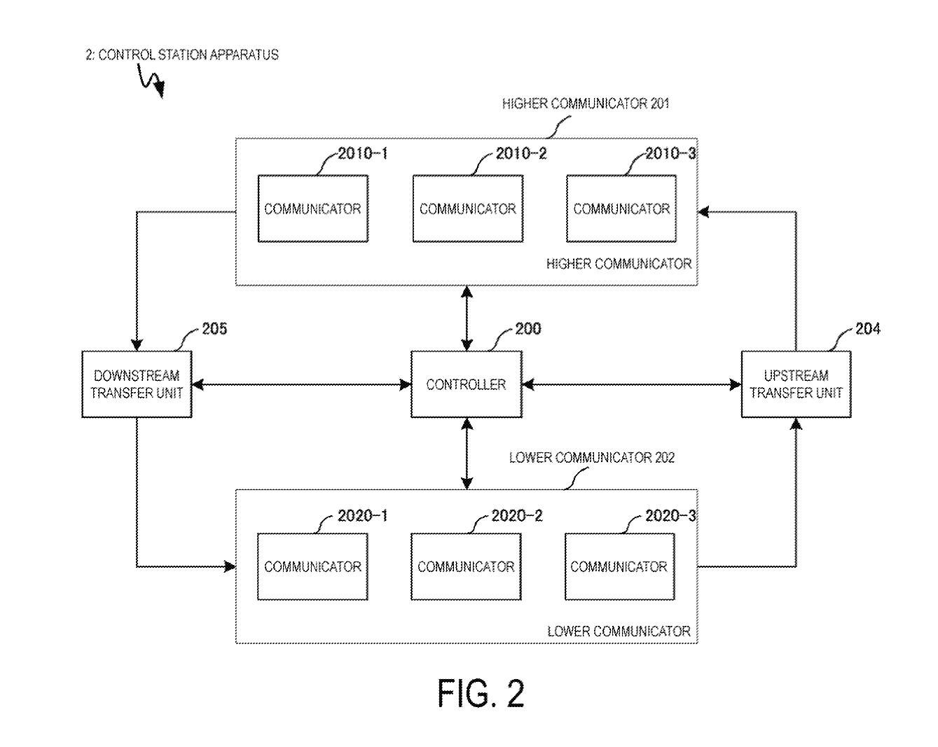

FIG. 2 is a block diagram illustrating a constitution example of the control station apparatus 2 according to the present embodiment. As illustrated in FIG. 2, the control station apparatus 2 according to the present embodiment includes a controller (control step) 200, a higher communicator (higher communication step) 201 (first communicator), a lower communicator (lower communication step) 202 (second communicator), an upstream transfer unit (upstream transfer step) 204 (first data transfer unit), and a downstream transfer unit (downstream transfer step) 205 (second data transfer unit). Although the higher communicator 201 includes communicators (communication steps) 2010-1 to 3, it is sufficient that the number of communicators 2010 included in the higher communicator 201 is at least one or more. Although the lower communicator 202 includes communicators (communication steps) 2020-1 to 3, it is sufficient that the number of communicators 2020 included in the lower communicator 202 is at least two or more.

The communicator 2010 included in the higher communicator 201 and the communicator 2020 included in the lower communicator 202 are capable of providing a communication service or being provided with a communication service, each using different communication methods. That is, the higher communicator 201 and the lower communicator 202 are capable of providing a communication service or being provided with a communication service, each using multiple communication methods.

The communicator 2010 of the higher communicator 201 includes a communication function defined by a communication method supported by the communicator 2010, and the communicator 2020 of the lower communicator 202 includes a communication function defined by a communication method supported by the communicator 2020. The above communication function includes, taking an OSI reference model as an example, a function for interpreting a Physical Layer, a Media Access Control (MAC) layer, a data link layer, a network layer, a transport layer, a session layer, a presentation layer, and an application layer.

A way of distinguishing communication methods provided by the communicator 2010 and the communicator 2020 is not specifically limited, and as described above, for example, each of the communicator 2020-1 and the communicator 2020-2 is capable of including a different radio access technique.

At least one of the communicators 2010 is capable of providing a communication service using a higher communication method in which the base station apparatus 1A provides a communication service. According to the above-described example, at least one of the communicators 2010 is capable of providing a communication service using the LTE.

A communication service provided by the higher communicator 201 is controlled at least partially by another device. According to the above-described example, in a case that the higher communication method provided by the base station apparatus 1A is the LTE, the higher communicator 201 supports a communication service using the LTE, but a communication service using the LTE is controlled by the base station apparatus 1A. That is, the higher communicator 201 of the control station apparatus 2 operates as a terminal apparatus viewed from the base station apparatus 1A.

The higher communicator 201 of the control station apparatus 2 operating as the terminal apparatus viewed from the base station apparatus 1A is capable of acquiring control information from the base station apparatus 1A via control channels, and is capable of notifying the base station apparatus 1A of control information. The above control channels include a first control channel and a second control channel. The first control channel is a cell-specific physical downlink control channel provided by the base station apparatus 1A, and is a physical channel capable of being acquired (detected) regardless whether the control station apparatus 2 is in an idle state or in a connected state. Further, the second control channel is a physical downlink control channel specific to the control station apparatus 2, and is a physical channel capable of being acquired only in a connected state. Here, the idle state is a state in which the base station apparatus 1A does not accumulate information of Radio Resource Control (RRC) (RRC_IDLE state), a state in which the control station apparatus 2 performs discontinuous reception (DRX), and the like, that is, a state in which transmission and/or reception of data is not performed immediately. Meanwhile, the connected state is a state in which the control station apparatus 2 retains network information (RRC_CONNECTED state, connected state), a state in which the control station apparatus 2 does not perform the discontinuous reception (DRX), and the like, that is, a state in which immediate data transmission and/or reception is possible. The first control channel is independent of RRC signalling specific to the control station apparatus 2, and is a channel that the control station apparatus 2 is capable of receiving. The second control channel is a channel configured by RRC signalling specific to the control station apparatus 2, and is a channel that the control station apparatus 2 is capable of receiving using RRC signalling specific to a terminal. That is, the first control channel is a channel that any control station apparatus 2 is capable of receiving with a previously limited configuration, and the second control channel is a channel for which a configuration specific to the control station apparatus 2 is easily changed.

The higher communicator 201 of the control station apparatus 2 operating as a terminal apparatus with respect to the base station apparatus 1A is capable of acquiring information broadcast from the base station apparatus 1A, and transmitting an RRC connection request message including identification information of own terminal apparatus to the base station apparatus 1A. The base station apparatus 1A, in a case of receiving the RRC connection request message transmitted from the control station apparatus 2, configures a Signaling Radio Bearer (SRB) for transmitting and/or receiving a communication control message between the above control station apparatus 2 and the base station apparatus 1A, and transmits an RRC connection setup message including information on the SRB, constitution information on a physical channel, and additionally various pieces of configuration information for the above control station apparatus 2, using a physical downlink shared channel.

The control station apparatus 2, in a case of receiving the RRC connection setup message transmitted from the base station apparatus 1A, is capable of transiting to a state of retaining network information (RRC_CONNECTED state, connected state). The control station apparatus 2 is capable of transmitting an RRC connection setup complete message indicating connection procedure completion to the base station apparatus 1A using a physical uplink shared channel. Subsequently, the higher communicator 201 of the control station apparatus 2 is capable of performing user data communication with the base station apparatus 1A. Thereafter, the control station apparatus 2 transmits or receives data, between the base station apparatus 1A and the control station apparatus 2 via the higher communicator 201, in a case of exchanging data, according to control by the base station apparatus 1A.

The control station apparatus 2A includes a function for providing the terminal apparatus 3A in the coverage 2A-1 with radio communication services. Hereinafter, a communication method in which the control station apparatus 2A provides the terminal apparatus 3A with communication services is also referred to as a lower communication method. Note that, as described above, a way of distinguishing (defining) communication methods is not limited specifically. For example, it is possible to distinguish lower communication methods according to the present embodiment by different Radio Access Techniques.

The lower communicator 202 of the control station apparatus 2A provides the terminal apparatus 3A with communication services using at least two different communication methods. For example, the lower communicator 202 of the control station apparatus 2A is capable of providing the terminal apparatus 3A with communication services by using Wireless local area network (wireless LAN) communication and D2D communication. Further, the control station apparatus 2A at least partially controls communication performed by the terminal apparatus 3A using the lower communication method.

The terminal apparatus 3A is capable of communicating with the control station apparatus 2A using the lower communication method.

The upstream transfer unit 204 of the control station apparatus 2A is capable of transferring data received by the lower communicator 202 and transmitted by the terminal apparatus 3A, to the higher communicator 201, for transmitting to the base station apparatus 1A. The higher communicator 201 is capable of transmitting data transferred from the upstream transfer unit 204, to the base station apparatus 1A. The upstream transfer unit 204 of the control station apparatus 2A may be regarded as transferring an upstream signal from the terminal apparatus 3 to the base station apparatus 1.

A downstream transfer unit 205 of the control station apparatus 2A is capable of transferring data received by the higher communicator 201 and transmitted by the base station apparatus 1A, to the lower communicator 202, for transmitting to the terminal apparatus 3A. The lower communicator 202 is capable of transmitting data transferred from the downstream transfer unit 205, to the terminal apparatus 3A. The downstream transfer unit 205 of the control station apparatus 2A may be regarded as transferring a downstream signal from the terminal apparatus 3 to the base station apparatus 1.

Note that, layers on which the upstream transfer unit 204 and the downstream transfer unit 205 transfer signals are not specifically limited. For example, in a case of transferring a signal received by the lower communicator 202 to the base station apparatus 1A via the higher communicator 201, a controller 200 may transfer on the PHY layer, or on the MAC layer.

Further, layers on which the controller 200 determines whether the upstream transfer unit 204 and the downstream transfer unit 205 transfer data or not is also not specifically limited. For example, the controller 200 determines, based on information on the PHY layer of a signal received by the lower communicator 202, whether the base station apparatus 1A is to transfer the above signal using the higher communicator 201 or not, and in a case of determining to transfer, the controller 200 is capable of controlling to transfer on the PHY layer.

Additionally, the controller 200 is capable of determining, based on information on the MAC layer of a signal received by the lower communicator 202, whether the base station apparatus 1A is to transfer the above signal using the higher communicator 201. Further, the controller 200, in a case of determining to transfer the above signal, may transfer on the PHY layer, or the MAC layer.

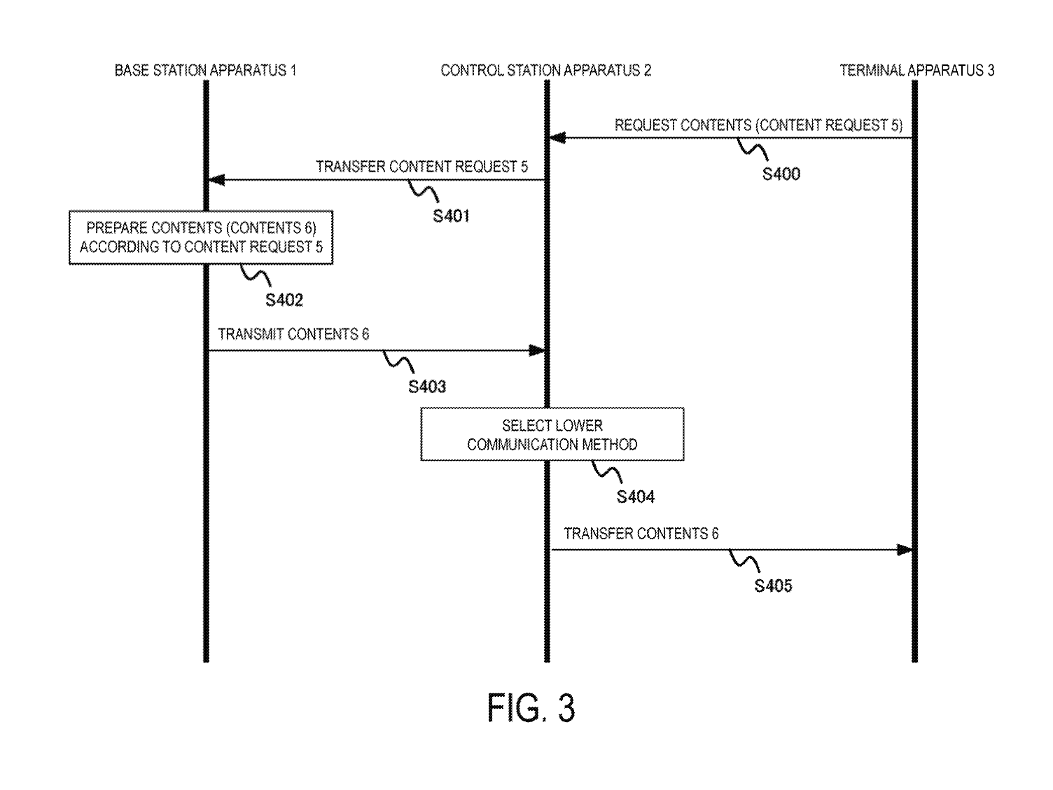

FIG. 3 is a sequence chart illustrating an example of communication of a communication system according to the present embodiment. First, the terminal apparatus 3 transmits a signal including a content request 5 for requesting contents (a service, an application) that own apparatus wants to acquire via a communication service, to the control station apparatus 2 using a lower communication method (Step S400). In the communication in Step S400, the control station apparatus 2 is capable of controlling communication performed by the terminal apparatus 3 using the lower communication method as needed. Note that, the above communication is capable of including selection of a lower communication method, used by the terminal apparatus 3 for transmitting a signal including the above content request 5. The controller 200 is capable of giving conditions in advance for selecting a prescribed lower communication method, or specifying multiple candidates for a lower communication method in advance, for the terminal apparatus 3.

Next, the control station apparatus 2 transmits the signal including the content request 5, using a higher communication method, to the base station apparatus 1 (Step S401). In the communication in Step S401, the higher communicator 201 of the control station apparatus 2 is at least partially controlled by the base station apparatus 1.

Next, the base station apparatus 1 prepares contents 6 requested by the content request 5 (Step S402). A method for the base station apparatus 1 to prepare the contents 6 is not specifically limited in the present embodiment. For example, the base station apparatus 1, as described above, is capable of acquiring the contents 6 from an external server connected via the external network 4.

Next, the base station apparatus 1 transmits a signal including the contents 6, using the higher communication method, to the control station apparatus 2 (Step S403). As in Step S401, in the communication in Step S403, the higher communicator 201 of the control station apparatus 2 is at least partially controlled by the base station apparatus 1.

Next, the controller 200 of the control station apparatus 2 selects a lower communication method used for transmitting the signal including the contents 6 received from the base station apparatus 1 to the terminal apparatus 3 (Step S404). As a communication method used by the lower communicator 202 for transmitting the signal including the contents 6 to the terminal apparatus 3, it is possible to use an identical communication method to a communication method used by the lower communicator 202 for receiving the signal including the content request 5. Additionally, as the communication method used by the lower communicator 202 for transmitting the signal including the contents 6 to the terminal apparatus 3, it is possible to use a different communication method from the communication method used by the lower communicator 202 for receiving the signal including the content request 5.

Next, the control station apparatus 2, based on the lower communication method selected by the controller 200, transmits the signal including the contents 6 to the terminal apparatus 3 (Step S405). The above is an example of communication of the communication system according to the present embodiment.

Instead of selecting the lower communication method by the content request signal 5, a lower communication method may be selected depending on a type of contents (a service, an application) configured for the control station apparatus 2 in advance. In addition, the control station apparatus may separately receive a quality request signal for contents other than the content request signal 5, and select a lower communication method. In addition to the above, a lower communication method may be selected by a protocol to be used. For example, in a case that a protocol, such as a Hypertext Transfer Protocol (HTTP), a Real Time Streaming Protocol (RTSP), or the like, that often treats large data, is used, a communication method with a high bit-rate may be selected, and in a case that a Real-time Transport Protocol (RTP)/Real-time Transport Control Protocol (RTCP), or the like, used for an IP phone or the like having small delay tolerance, is used, a communication method that assures a maximum delay amount may be selected. This protocol is not limited to a protocol for an application layer, and a protocol for other layers such as a transport layer and a network layer may be used. The above-described selection criteria for a communication method may be changed by a terminal apparatus, another control station apparatus, or the like.

In Step S404, the method for the controller 200 of the control station apparatus 2 to select a lower communication method is not specifically limited. For example, the control station apparatus 2, based on communication quality required for communicating the contents 6 itself or the signal including the contents 6, is capable of selecting a lower communication method. Here, the communication quality may include at least one of a Peak data rate, a User experienced data rate, Spectrum efficiency, Mobility, Latency, Connection density, Network energy efficiency, and Area traffic capacity. Additionally, the communication quality may also include values and schemes necessary for calculating the above-described eight types of communication quality (e.g., a reception signal-to-noise plus interference power ratio, a reception signal-to-noise power ratio, a communication bandwidth, a carrier frequency, a transmission scheme, a modulation scheme, a coding rate, or the like). For example, in a case that a prescribed peak data rate is required for communication of the signal including the contents 6, the controller 200 is capable of selecting a communication method satisfying the prescribed peak data rate as a lower communication method.

Additionally, the controller 200, based on communication quality of a higher communication method, is capable of selecting a lower communication method. For example, in a case that a user experienced data rate of a higher communication method is a prescribed data rate, a communication method satisfying a user experienced data rate equivalent to the above prescribed data rate may be selected as a lower communication method. This is because, in a case that the user experienced data rate of the lower communication method is higher than a prescribed data rate, the user experienced data rate of the lower communication method possibly becomes in an excessive manner.

Note that, although a case in which the terminal apparatus 3 requests contents is taken as an example in communication illustrated in FIG. 3, the communication system according to the present embodiment also includes a case in which contents are requested to the terminal apparatus 3.

In this case, the control station apparatus 2 receives the content request 5 from the base station apparatus 1A, and transmits the content request 5 to the terminal apparatus 3 using the lower communication method. Then, the control station apparatus 2 receives the signal including the contents 6 prepared by the terminal apparatus 3 in response to the above content request 6 using the lower communication method, and transmits the above contents 6 using the higher communication method to the base station apparatus 1.

Here, the control apparatus 200 of the control station apparatus 2 is capable of selecting an identical communication method, or different communication methods, for the lower communication method used for transmitting the content request 5 to the terminal apparatus 3, and for the lower communication method used for receiving the contents 6 prepared based on the content request 5 from the terminal apparatus 3. The control station apparatus 2 is capable of additionally including information indicating a communication method used for transmitting the contents 6 in the signal including the content request 5 and is capable of transmitting to the terminal apparatus 3. Further, the control station apparatus 2 is capable of notifying the terminal apparatus 3 of information indicating a selection method of a lower communication method used by the terminal apparatus 3 in advance.

Also in this case, the method for the controller 200 of the control station apparatus 2 to select the lower communication method is not specifically limited. For example, the control station apparatus 2, based on communication quality required for communicating the contents 6 itself or the signal including the contents 6 and the signal inc luding the content request 5, is capable of selecting a lower communication method.

According to the above-described method, the control station apparatus 2 is capable of maintaining connectivity with the base station apparatus 1, while flexibly changing a communication method with the terminal apparatus 3.

### 2. Second Embodiment

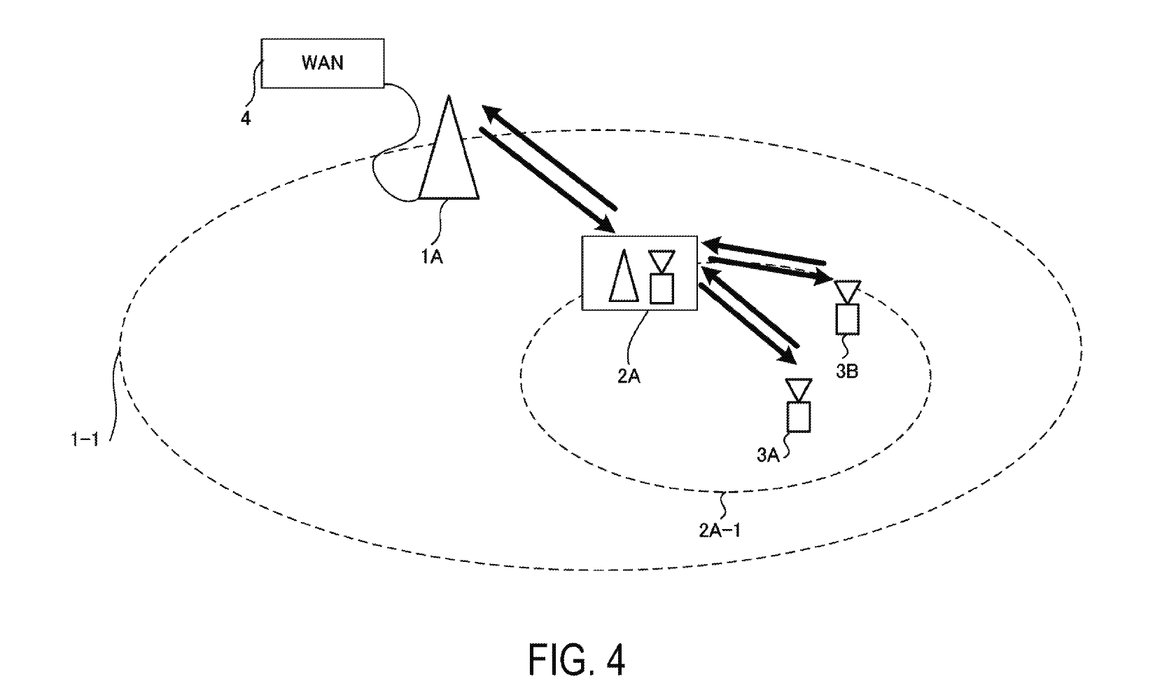

FIG. 4 is a diagram illustrating an example of a communication system according to a second embodiment. As illustrated in FIG. 4, in the communication system according to the present embodiment, two terminal apparatuses 3, that is, the terminal apparatus 3A and the terminal apparatus 3B (second communication apparatuses) are included in the coverage 2A-1 of the control station apparatus 2A.

As in the first embodiment, the control station apparatus 2 is capable of providing the terminal apparatus 3 in the coverage 2A-1 with communication services, based on a lower communication method.

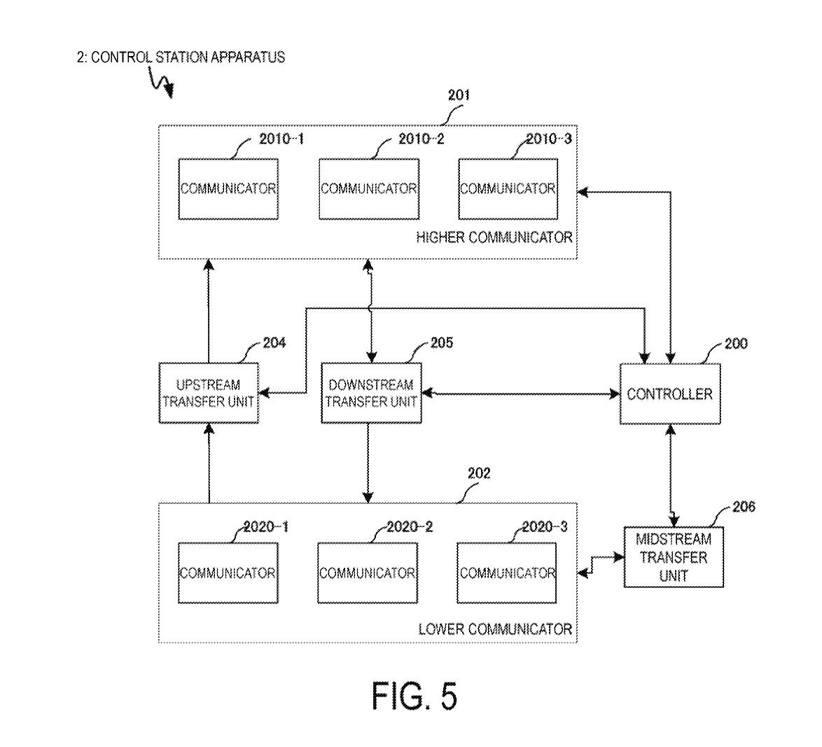

FIG. 5 is a block diagram illustrating a constitution example of the control station apparatus 2 according to the present embodiment. As illustrated in FIG. 5, the control station apparatus 2 according to the present embodiment further includes, in addition to the devices illustrated in FIG. 2, a midstream transfer unit (midstream transfer step) 206 (third data transfer unit).

The midstream transfer unit 206 is capable of inputting a signal received by the lower communicator 202 and transmitted by the terminal apparatus 3, to the lower communicator 202 again, for transferring to another terminal apparatus 3. The controller 200 is capable of selecting a lower communication method used for transferring a signal transmitted by the terminal apparatus 3, to another terminal apparatus 3. The midstream transfer unit 206 of the control station apparatus 2A may be regarded as transferring a midstream signal from the terminal apparatus 3A to the terminal apparatus 3B (or from the terminal apparatus 3B to the terminal apparatus 3A).

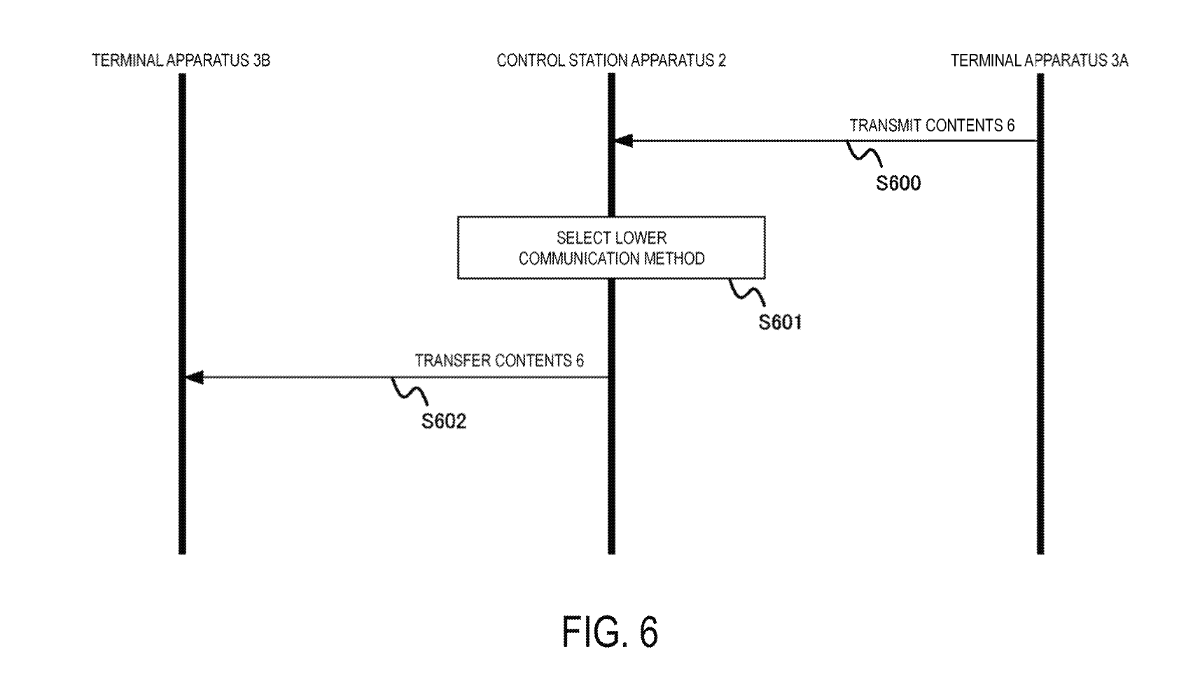

FIG. 6 is a sequence chart illustrating an example of communication of a communication system according to the present embodiment. First, the terminal apparatus 3A transmits the contents 6, using a lower communication method to the control station apparatus 2 (Step S600). As in the first embodiment, the lower communication method used in Step S600 is at least partially controlled by the control station apparatus 2.

Next, the controller 200 of the control station apparatus 2 selects a lower communication method used by the lower communicator 202 for transmitting the contents 6 received from the terminal apparatus 3A to the terminal apparatus 3B (Step S601). Here, as the lower communication method selected by the controller 200, it is possible to use an identical communication method to the communication method used by the lower receiver 202 for receiving the signal including the contents 6 from the terminal apparatus 3A, or use a different communication method.

Next, the control station apparatus 2, based on the lower communication method selected by the controller 200, transmits the signal including the contents 6 to the terminal apparatus 3B (Step S602). The above is a diagram illustrating an example of the communication of the communication system according to the present embodiment.

In Step S601, the method for the controller 200 of the control station apparatus 2 to select the lower communication method is not specifically limited. The controller 200, for example, the control station apparatus 2, based on communication quality required for communicating the contents 6 itself or the signal including the contents 6, is capable of selecting a lower communication method.

Additionally, the controller 200, based on communication quality of a higher communication method, is capable of selecting a lower communication method. For example, in a case that a communication method selected by a lower communication method includes a communication method using part of a radio resource used by a higher communication method, and the higher communicator 201 uses most of the above radio resource by communication based on the higher communication method performed between the base station apparatus 1A and the higher communicator 201, the controller 200 is capable of not selecting a communication method using the above radio resource, or is capable of lowering selection priority, as a lower communication method.

Further, the controller 200 of the control station apparatus 2, based on the contents of the contents 6, is capable of selecting a lower communication method. The controller 200 is capable of reading information of each of layers defined in an OSI reference model from the signal including the contents 6 received from the terminal apparatus 3A, and is capable of selecting a lower communication method used for transmitting the signal including the contents 6 to the terminal apparatus 3B, based on the information of each of the layers. For example, the controller 200 is capable of acquiring information on an application layer for the signal including the above contents 6, and is capable of selecting a lower communication method, based on required conditions (e.g., latency) requested by the above contents 6 on the application layer.

Additionally, the layer on which the control station apparatus 2 transfers the signal including the contents 6 received from the terminal apparatus 3A to the terminal apparatus 3B is not specifically limited. For example, the control station apparatus 2, for example, the controller 200 is capable of acquiring information on the application layer for the signal including the above contents 6, and is capable of transferring on the application layer. In this case, the terminal apparatus 3B, for the above contents 6, at least in the application layer, recognizes the control station apparatus 2 as a transmission source terminal.

Additionally, the control station apparatus 2, after performing a prescribed process for the information of each of the layers of the signal including the contents 6 received from the terminal apparatus 3A, is capable of transferring to the terminal apparatus 3B. The above prescribed process includes Compressing, Decompressing, Processing, Deleting, Adding, Storing of information, and the like. For example, the control station apparatus 2 is capable of acquiring information on the application layer for the signal including the above contents 6, performing a prescribed process for the information on the application layer, and transferring on the application layer. At this time, the controller 200, based on the prescribed process, performed for a signal of each of the layers of the signal including the contents 6 received from the terminal apparatus 3A, performed by the control station apparatus 2, is capable of selecting a lower communication method for transferring the above signal to the terminal apparatus 3B. For example, in a case that the control station apparatus 2 applies the above prescribed process to the signal including the contents 6 and communication quality requested by the above contents 6 changes, the control station apparatus 2 is capable of selecting a lower communication method satisfying the above communication quality, and is capable of transmitting the above contents 6 to the terminal apparatus 3B.

Additionally, the communication system according to the present embodiment, as in the first embodiment, is capable of requesting contents from the terminal apparatus 3A to the terminal apparatus 3B. In this case, the control station apparatus 2 is capable of using an identical lower communication method, or using different lower communication methods, for a case of receiving the content request 5 from the terminal apparatus 3A, for a case of transmitting the above content request 5 to the terminal apparatus 3B, for a case of receiving the above contents 6 from the terminal apparatus 3B, and for a case of transmitting the above contents 6 to the terminal apparatus 3A. Further, as illustrated in the above example, the control station apparatus 2 is capable of performing a prescribed process for the information on each of the layers of the above content request 5 and the contents 6. Further, the controller 200, based on the above prescribed process, is capable of selecting a lower communication method used for each transmission.

According to the above-described method, in a case that the control station apparatus 2 receives a signal transmitted from the terminal apparatus 3A to the terminal apparatus 3B, and in a case that the above signal is transmitted to the terminal apparatus 3B, it is possible to select a proper lower communication method.

Further, the terminal apparatus 3A may request, other than the content request, a process of contents managed by the terminal apparatus 3A, to the control station apparatus 2. The contents managed by the terminal apparatus 3A may include, various types of information stored in the terminal apparatus 3A, various types of information inputted to the terminal apparatus 3A, or information that is obtained by processing the above information. The control station apparatus 2 may process contents that the terminal apparatus 3A requests to process, and transmit various contents after being processed to the terminal apparatus 3A or the terminal apparatus 3B. A lower communication method may be selected depending on a type of contents in a case that the terminal apparatus 3A requests the control station apparatus 2 to process, or on types of various contents after being processed by the control station apparatus.

### 3. Third Embodiment

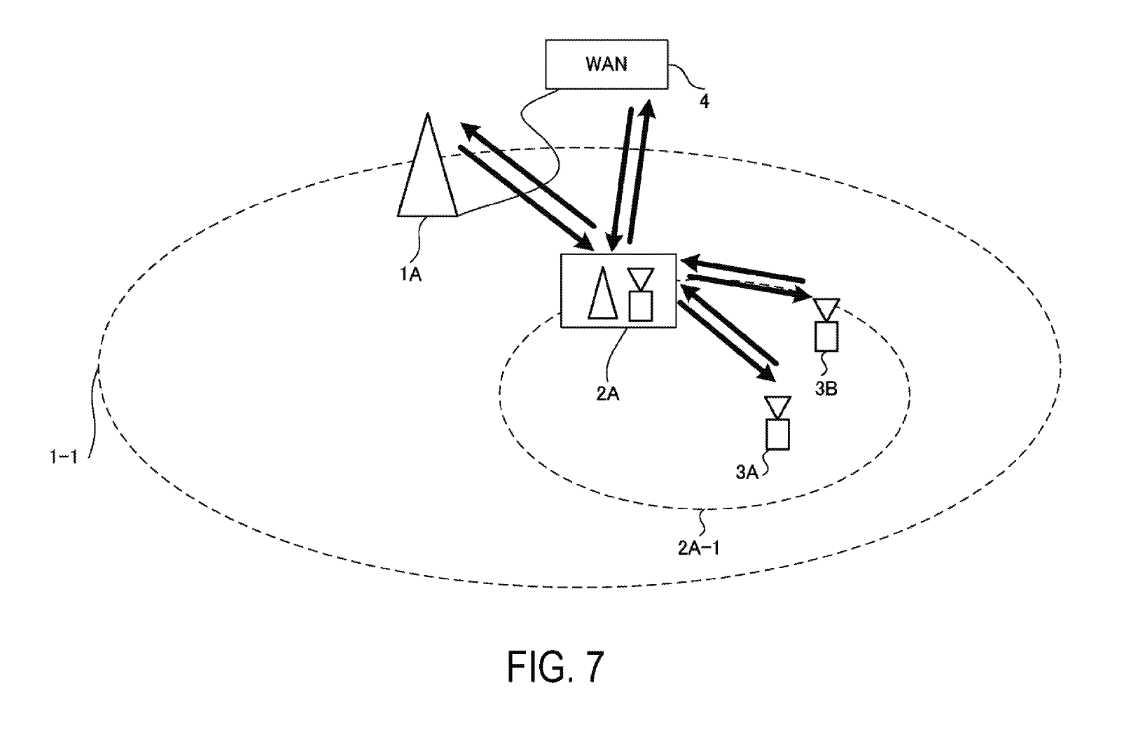

FIG. 7 is a diagram illustrating a constitution example of a communication system according to the present embodiment. As illustrated in FIG. 7, in the communication system according to the present embodiment, it is possible to directly connect the control station apparatus 2 with the external network 4.

A device constitution of the control station apparatus 2 according to the present embodiment is identical to a device constitution illustrated in FIG. 7. However, any one of the communicators 2010 included in the higher communicator 201 supports a higher communication method capable of communicating with an external network. Here, the higher communication method includes wire communication represented by an optical fiber. The controller 200 is capable of selecting a higher communication method used by the higher communicator 201. Further, the controller 200 is capable of selecting a destination terminal to which the higher communicator 201 transmits a signal. Hereinafter, in a case that an expression “the controller 200 selects a higher communication method” is used, the controller 200 also includes actions of selecting a destination terminal to which the higher communicator 201 transmits a signal.

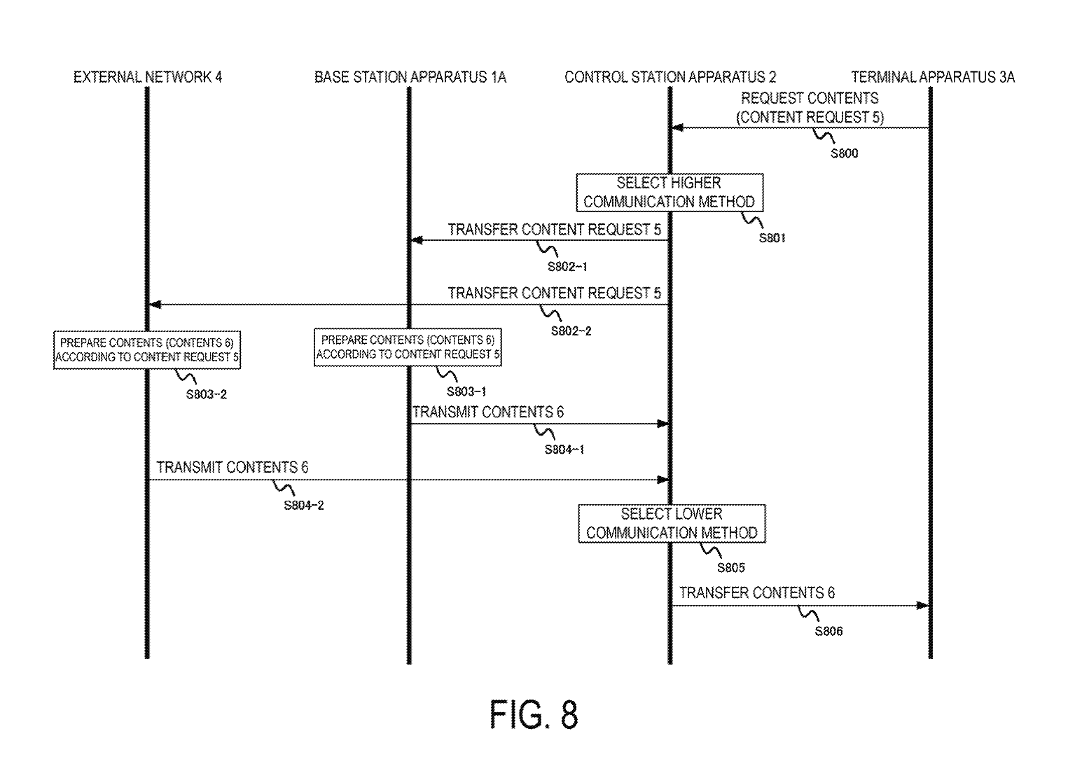

FIG. 8 is a sequence chart illustrating an example of communication of a communication system according to the present embodiment. First, the terminal apparatus 3A transmits a signal including the content request 5 for requesting contents that own apparatus wants to acquire via a communication service, to the control station apparatus 2 using a lower communication method (Step S800). In the communication in Step S800, the control station apparatus 2 is capable of controlling communication performed by the terminal apparatus 3 using the lower communication method as needed.

Next, the controller 200 of the control station apparatus 2 selects a higher communication method for transmitting a signal including the content request 5 (Step S801). Here, the controller 200 is also capable of selecting a transfer destination to which the content request 5 is transferred.

Next, based on the higher communication method selected by the controller 200, the signal including the content request 5 is transmitted to the transfer destination selected by the controller 200 (Step S802-1 or Step S802-2). In the communication in Step S802, in a case that the signal including the content request 5 is transmitted to the base station apparatus 1, the higher communicator 201 of the control station apparatus 2 is at least partially controlled by the base station apparatus.

Next, the base station apparatus 1A and the external network 4 prepare the contents 6 requested by the content request 5 (Step S803-1 or Step S803-2). A method for the base station apparatus 1 to prepare the contents 6 is not specifically limited in the present embodiment. For example, the base station apparatus 1, as described above, is capable of acquiring the contents 6 from an external server connected via the external network 4. A method for the external network 4 to prepare the contents 6 is not specifically limited as well. For example, the external network 4, is capable of acquiring the contents 6 from an external server connected with own network.

Next, each of the base station apparatus 1A and the external network 4 transmits a signal including the contents 6, using the higher communication method to the control station apparatus 2 (Step S804-1 or Step S804-2). As in Step S802, in the communication in Step S804, in a case of receiving the signal including the contents 6 from the base station apparatus 1A, the higher communicator 201 of the control station apparatus 2 is at least partially controlled by the base station apparatus 1.

Next, the controller 200 of the control station apparatus 2 selects a lower communication method used for transmitting the signal including the contents 6 received from the base station apparatus 1 or the external network 4 to the terminal apparatus 3 (Step S805). As a communication method used by the lower communicator 202 for transmitting the signal including the contents 6 to the terminal apparatus 3, it is possible to use an identical communication method to a communication method used by the lower communicator 202 for receiving the signal including the content request 5. Additionally, as the communication method used by the lower communicator 202 for transmitting the signal including the contents 6 to the terminal apparatus 3, it is possible to use a different communication method from the communication method used by the lower communicator 202 for receiving the signal including the content request 5.

Next, the control station apparatus 2, based on the lower communication method selected by the controller 200, transmits the signal including the contents 6 to the terminal apparatus 3 (Step S806). The above is an example of communication of the communication system according to the present embodiment.

In Step S801, the method for the controller 200 to select the higher communication method is not specifically limited. For example, the controller 200, based on communication quality requested by the signal including the content request 5, is capable of selecting a higher communication method. For example, in a case that the above signal requests a prescribed peak data rate, the controller 200 is capable of selecting a communication method satisfying the above prescribed peak data rate as a higher communication method.

Additionally, the controller 200, in a case of receiving the signal including the content request 5, based on the lower communication method selected by the lower communicator 202, is capable of selecting a higher communication method. For example, in a case that a user experienced throughput acquired by the lower communication method selected by the lower communicator 202 is a prescribed value, the controller 200 is capable of selecting a higher communication method satisfying a user experienced throughput equivalent to the above prescribed value among higher communication methods.

In Step S801, the method for the controller 200 to select the lower communication method is not specifically limited. For example, the controller 200, based on communication quality requested by the contents 6 itself or the signal including the contents 6, is capable of selecting a lower communication method. For example, in a case that the above signal requests a prescribed network energy efficiency, the controller 200 is capable of selecting a communication method satisfying the above prescribed network energy efficiency as a lower communication method.

Additionally, the controller 200, in a case of receiving the contents 6, based on the higher communication method selected by the higher communicator 201, is capable of selecting a lower communication method. For example, in a case of receiving the contents 6, and in a case that a user experienced throughput acquired by the higher communication method selected by the higher communicator 201 is a prescribed value, the controller 200 is capable of selecting a communication method capable of acquiring a user experienced throughput equivalent to the above prescribed value as a lower communication method.

Additionally, the control station apparatus 2, as in the first and the second embodiments, after performing a prescribed process for information of each of layers of the signal including the contents 6 received from the base station apparatus 1A or the external network 4, is capable of transferring to the terminal apparatus 3B. For example, the control station apparatus 2 is capable of acquiring information on the application layer for the signal including the above contents 6, performing a prescribed process for the information on the application layer, and transferring on the application layer. At this time, the controller 200, based on the prescribed process, performed for a signal of each of the layers of the signal including the above contents 6, performed by the control station apparatus 2, is capable of selecting a lower communication method for transferring the above signal to the terminal apparatus 3B. For example, in a case that the control station apparatus 2 applies the above prescribed process to the signal including the contents 6 and communication quality requested by the above contents 6 changes, the control station apparatus 2 is capable of selecting a lower communication method satisfying the above communication quality, and is capable of transmitting the above contents 6 to the terminal apparatus 3B.

Note that, according to the example in FIG. 7, destination devices to which the control station apparatus 2 transmits signals using the higher communication method are only the base station apparatus 1A and the external network 4, but the control station apparatus 2 is also capable of transmitting a signal using the higher communication method to other devices. For example, although not illustrated in FIG. 7, the control station apparatus 2 is capable of transmitting a signal using the higher communication method, to the base station apparatus 1B different from the base station apparatus 1A. In this case, any one of the communicators 2010 included in the higher communicator 201 of the control station apparatus 2 supports a communication method in which the base station apparatus 1B provides communication services, and communication control of the above communicator 2010 is at least partially controlled by the base station apparatus 1B.

According to the above-described method, the control station apparatus 2 is capable of appropriately selecting a higher communication method for transmitting the signal including the content request 5 transmitted from the terminal apparatus 3A, and additionally, based on the selected higher communication method, is capable of appropriately selecting a lower communication method.

### 4. Fourth Embodiment

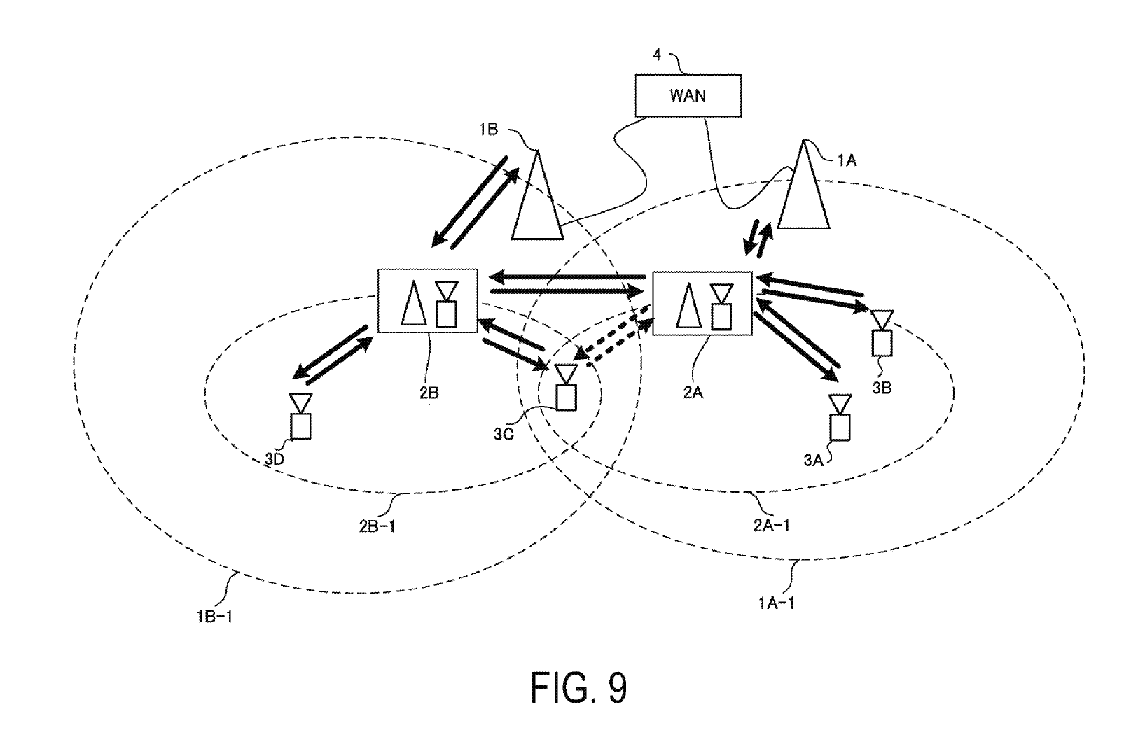

FIG. 9 is a schematic diagram illustrating an example of a communication system according to the present embodiment. As illustrated in FIG. 9, the communication system according to the present embodiment includes the base station apparatus 1A, the control station apparatus 2A in coverage 1A-1 of the base station apparatus 1A, and the terminal apparatus 3A, terminal apparatus 3B and the terminal apparatus 3C in the coverage 2A-1 of the control station apparatus 2A. Additionally, the communication system according to the present embodiment includes the base station apparatus 1B, the control station apparatus 2B in coverage 1B-1 of the base station apparatus 1B, and the terminal apparatus 3C and a terminal apparatus 3D in coverage 2B-1 of the control station apparatus 2B. Additionally, each of the base station apparatus 1A and the base station apparatus 1B is connected with the external network 4. In this illustration, although the base station apparatus 1A and the base station apparatus 1B are connected with an identical external network 4, obviously, may each be connected with different external networks 4.

Further, the control station apparatus 2A and the control station apparatus 2B may be contained as terminal apparatuses in an identical base station apparatus 1A. In addition, as in the third embodiment, each of the control station apparatus 2A and the control station apparatus 2B may provide the external network 4 with communication services, using a higher communication method.

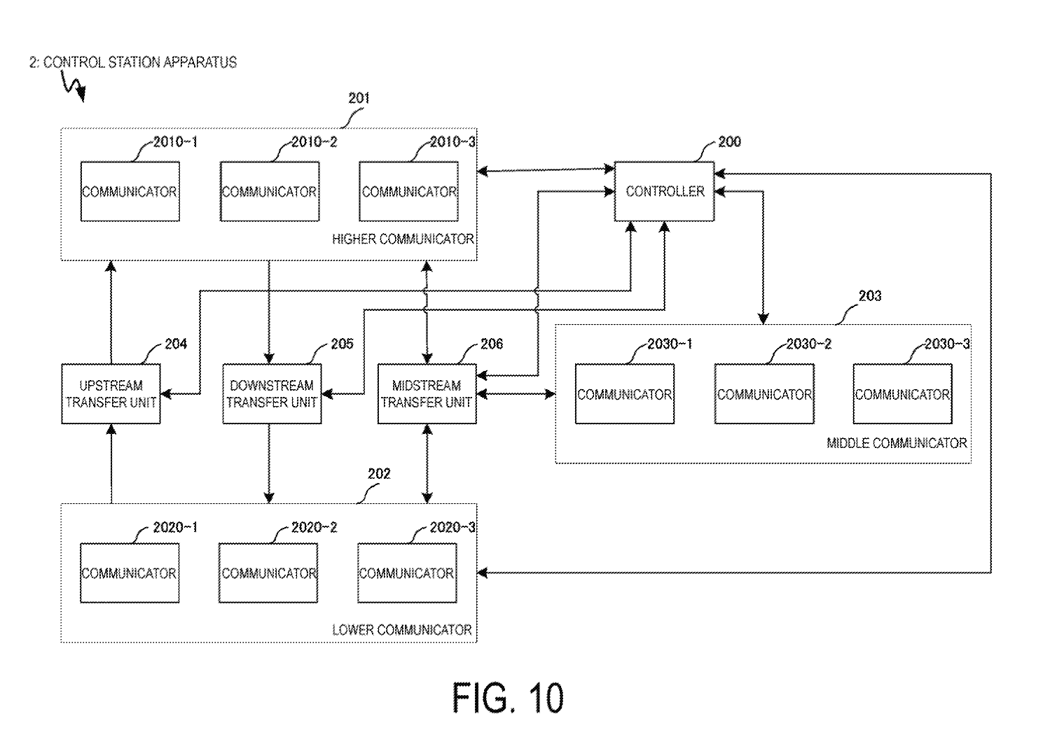

FIG. 10 is a block diagram illustrating a constitution example of the control station apparatus 2 according to the present embodiment. As illustrated in FIG. 10, the control station apparatus 2 according to the present embodiment further includes, in addition to the devices illustrated in FIG. 5, a middle communicator (middle communication step) 203 (third communicator). The middle communicator 203 further includes communicators (communication steps) 2030-1 to 3. Note that, it is sufficient that at least one communicator 2030 is included.

The control station apparatus 2 according to the present embodiment is capable of providing another control station apparatus 2 including the middle communicator 203 with communication services via the middle communicator 203. Hereinafter, a communication method that the control station apparatus 2 uses to provide another control station apparatus 2 with communication services is also referred to as a middle communication method. The controller 200, among multiple communication methods, is capable of selecting a middle communication method. A communication method that is selectable by the controller 200 is a communication method supported by the communicator 2030 included in the middle communicator 203.

Further, the midstream transfer unit 206 of the control station apparatus 2A according to the present embodiment may be regarded as transferring a midstream signal from the control station apparatus 2A to the control station apparatus 2B.

The control station apparatus 2A according to the present embodiment contains the terminal apparatus 3A and the terminal apparatus 3B positioned in the coverage 2A-1. That is, the control station apparatus 2A is capable of transmitting and/or receiving the signal including the content request 5 or the contents 6 prepared in accordance with the content request 5, for the terminal apparatus 2A and the terminal apparatus 2B respectively, via the lower communicator 202. At that time, the controller 200 is capable of selecting a lower communication method used for transmitting the signal including the above content request 5 or the contents 6 prepared in accordance with the content request 5. Similarly, the control station apparatus 2B contains the terminal apparatus 3C and the terminal apparatus 3D positioned in the coverage 2B-1, and the controller 200 is also similarly capable of selecting a lower communication method.

Meanwhile, the control station apparatus 2A and the control station apparatus 2B are capable of transmitting and/or receiving a signal with each other, based on a middle communication method via the middle communicator 203. Accordingly, as for each of the control station apparatus 2A and the control station apparatus 2B according to the present embodiment, own device is not always required to transmit a signal to a base station apparatus and an external network via the higher communicator 201, and is capable of transmitting a signal to a base station apparatus and an external network via another control station apparatus.

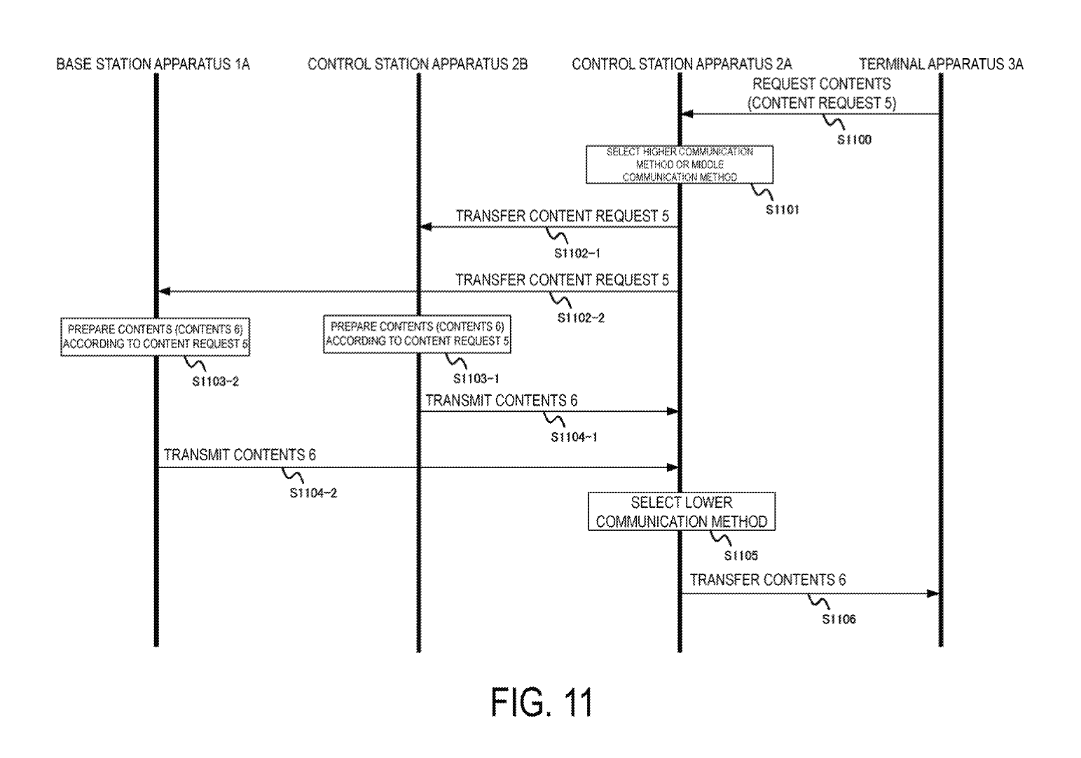

FIG. 11 is a sequence chart illustrating an example of communication of the communication system according to the present embodiment. First, the terminal apparatus 3A transmits a signal including the content request 5 for requesting contents that own apparatus wants to acquire via a communication service, to the control station apparatus 2 using a lower communication method (Step S1100). In the communication in Step S1100, as in the first to the third embodiments, the control station apparatus 2 is capable of controlling communication performed by the terminal apparatus 3 using the lower communication method as needed.

Next, the controller 200 of the control station apparatus 2 selects whether the higher communication method is used or the middle communication method is used for transmitting the signal including the content request 5 (Step S1101). Additionally, the controller 200, after selecting transmission by the higher communication method or transmission by the middle communication method, also selects a communication method to use as the higher communication method or the middle communication method.

Next, based on the higher communication method or the middle communication method selected by the controller 200, the signal including the content request 5 is transmitted to a transfer destination selected by the controller 200 (Step S1102-1 or Step S1102-2). In the communication in Step S1102, in a case that the signal including the content request 5 is transmitted to the base station apparatus 1A, the higher communicator 201 of the control station apparatus 2 is at least partially controlled by the base station apparatus 1A.

Additionally, in the communication in Step S1102, in a case that the signal including the content request 5 is transmitted to the control station apparatus 2B, the middle communicator 203 of the control station apparatus 2A may be at least partially controlled by the base station apparatus 2B, or may be entirely controlled by the control station apparatus 2A. In the following descriptions, communication control of the middle communicator 203 included in the control station apparatus 2 may be at least partially controlled by another control station apparatus 2, or the above communication control may be entirely controlled by own device. Further, in a case that a communication system includes multiple control station apparatuses 2, one of the control station apparatuses 2 is also capable of becoming a central control apparatus 7, and controlling communication of the middle communicator 203 of another control station apparatus 2.

Next, each of the control station apparatus 2B and the base station apparatus 1A prepares the contents 6 requested by the content request 5 (Step S1103-1 or Step S1103-2). Operations in Step S1103-2 are, for example, similar to the operations in Step S402, thus descriptions thereof will be omitted. Operations in Step 1103-1 are, for example, similar to the operations in Step S401 to Step S403 except that the control station apparatus 2B transfers the content request 5 to the base station apparatus 1B, thus descriptions thereof will be omitted.

Next, each of the control station apparatus 2B and the base station apparatus 1A transmits the signal including the contents 6, using the higher communication method to the control station apparatus 2 (Step S1104-1 or Step S1104-2). As in Step S1102-2, in the communication in Step S1104-2, in a case of receiving the signal including the contents 6 from the base station apparatus 1A, the higher communicator 201 of the control station apparatus 2 is at least partially controlled by the base station apparatus 1.

In the communication in Step S1104-1, communication control of the middle communicator 203 of the control station apparatus 2 may be partially controlled by the control station apparatus 2B, or may be entirely controlled by own device.

Next, the controller 200 of the control station apparatus 2 selects a lower communication method used for transmitting the signal including the contents 6 received from the control station apparatus 2B or the base station apparatus 1A to the terminal apparatus 3 (Step S1105). As a communication method used by the lower communicator 202 for transmitting the signal including the contents 6 to the terminal apparatus 3, it is possible to use an identical communication method to a communication method used by the lower communicator 202 for receiving the signal including the content request 5. Additionally, as the communication method used by the lower communicator 202 for transmitting the signal including the contents 6 to the terminal apparatus 3, it is possible to use a different communication method from the communication method used by the lower communicator 202 for receiving the signal including the content request 5.

Next, the control station apparatus 2, based on the lower communication method selected by the controller 200, transmits the signal including the contents 6 to the terminal apparatus 3 (Step S1106). The above is an example of communication of the communication system according to the present embodiment.

In Step S1101, in a case of transmitting the signal including the content request 5, whether the higher communication method or the middle communication method is to be selected by the controller 200, also a method for selecting a communication method actually used by the higher communicator 201 and the middle communicator 203, is not specifically limited. As in the first to the third embodiments, the controller 200, based on communication quality requested by the signal including the content request 5, is capable of selecting either one of a higher communication method and a middle communication method. For example, in a case that a prescribed value of a peak data rate is requested by the signal including the above content request 5, the controller 200, in a case that a peak data rate that the higher communication method is capable of providing does not satisfy the above prescribed value, is capable of selecting a middle communication method satisfying the prescribed peak data rate.

In Step S1105, the method for the controller 200 to select the lower communication method used for transmitting the signal including the contents 6 is not specifically limited. As in the first to the third embodiments, the controller 200, based on communication quality requested by the contents 6 itself or the signal including the contents 6, is capable of selecting a lower communication method.

Note that, although the control station apparatus 2B contains the terminal apparatus 3C, according to the example in FIG. 9, the terminal apparatus 3C is also positioned in the coverage 2A-1 of the control station apparatus 2A. Accordingly, the terminal apparatus 3C is not always required to transmit the signal including the content request 5 and the signal including the contents 6, based on the lower communication method, to the control station apparatus 2B, and the terminal apparatus 3C is capable of transmitting the signal including the content request 5 and the signal including the contents 6, based on the lower communication method, to the control station apparatus 2A.

For example, in a case that the lower communicator 202 is not capable of securing a radio medium in a case of transmitting the signal including the contents 6 to the terminal apparatus 3C via the lower communicator 202 of the control station apparatus 2B, the control station apparatus 2B is capable of transferring the signal including the above contents 6 to the control station apparatus 2A via the middle communicator 203. The control station apparatus 2A is capable of transferring the signal including the above contents 6 received via the middle communicator 203 from the control station apparatus 2B, to the terminal apparatus 3C via the lower communicator 202.

According to the above-described method, the control station apparatus 2 is capable of transmitting a signal to the base station apparatus 1 and a terminal apparatus via another control station apparatus 2 other than own device, using a middle communication method provided by the middle communicator 203.

### 5. Common to All Embodiments

Communication methods supported by the higher communicator 201, the middle communicator 202 and the lower communicator 203 may include a common communication method.

Additionally, it is possible to use a control station apparatus according to an aspect of the present invention in Dual connectivity (DC) in which signals are transmitted (or received) from multiple transmission points (or to multiple reception points), or in Multihomed environments. It is possible to use the control station apparatus for communication with at least one of multiple transmission points (or reception points) connected by the DC. Further, it is possible to use a control station apparatus according to an aspect of the present invention for carrier aggregation (CA) that uses multiple component carriers (CC). It is possible to use the control station apparatus only for a primary cell, only for a secondary cell, or for both the primary cell and the secondary cell, among the multiple CCs subjected to the CA.

A program running on the control station apparatus according to an aspect of the present invention is a program (a program for causing a computer to operate) that controls a CPU and the like in such a manner as to enable the functions according to the above-described embodiments of the present invention. The information handled by these devices is temporarily held in a RAM at the time of processing, and is then stored in various types of ROMs, HDDs, and the like, and read out by the CPU as necessary to be edited and written. Here, a semiconductor medium (a ROM, a non-volatile memory card, or the like, for example), an optical recording medium (DVD, MO, MD, CD, BD, or the like, for example), a magnetic recording medium (a magnetic tape, a flexible disk, or the like, for example), and the like can be given as examples of recording media for storing the programs. In addition to realizing the functions of the above-described embodiments by executing loaded programs, the functions of the present invention are realized by the programs running cooperatively with an operating system, other application programs, or the like in accordance with instructions included in those programs.

In a case of delivering these programs to market, the programs can be stored in a portable recording medium, or transferred to a server computer connected via a network such as the Internet. In this case, the storage device serving as the server computer is also included in the present invention. Furthermore, some or all portions of each of the terminal apparatus and the base station apparatus in the above-described embodiments may be realized as LSI, which is a typical integrated circuit. The functional blocks of the reception device may be individually realized as chips, or may be partially or completely integrated into a chip. In a case that the functional blocks are integrated into a chip, an integrated circuit control unit for controlling them is added.

The circuit integration technique is not limited to LSI, and the integrated circuits for the functional blocks may be realized as dedicated circuits or a general-purpose processor. Furthermore, in a case where with advances in semiconductor technology, a circuit integration technology with which an LSI is replaced appears, it is also possible to use an integrated circuit based on the technology.

Note that the invention of the present patent application is not limited to the above-described embodiments. The control station apparatus according to the invention of the present patent application, needless to say, can be applied to a fixed-type electronic apparatus installed indoors or outdoors, or a stationary-type electronic apparatus, for example, an AV apparatus, a kitchen apparatus, a cleaning or washing machine, an air-conditioning apparatus, office equipment, a vending machine, and other household apparatuses.

The embodiments of the invention have been described in detail thus far with reference to the drawings, but the specific configuration is not limited to the embodiments. Other designs and the like that do not depart from the essential spirit of the invention also fall within the scope of the claims.

### INDUSTRIAL APPLICABILITY

The present invention is preferably used for a control station apparatus, a communication method, and a communication system.

The present international application claims priority based on JP 2016-039736 filed on Mar. 2, 2016, and all the contents of JP 2016-039736 are incorporated in the present international application by reference.

### REFERENCE SIGNS LIST

1, 1A, 1B Base station apparatus
2, 2A, 2B Control station apparatus
3, 3A, 3B, 3C, 3D Terminal apparatus
4 External network
5 Content request
6 Content
7 Central control apparatus
200 Controller
201 Higher communicator
2010-1 to 3, 2020-1 to 3, 2030-1 to 3 Communicator
202 Lower communicator
203 Middle communicator
204 Upstream transfer unit
205 Downstream transfer unit
206 Midstream transfer unit

1. A control station apparatus, at least comprising:
a first communicator configured to communicate as a terminal with a base station apparatus,
a second communicator configured to communicate with a first communication apparatus with at least two communication methods,
a controller configured to select one communication method from the at least two communication methods,
a first data transfer unit configured to transmit data transmitted from the first communication apparatus to the base station apparatus, and
a second data transfer unit configured to transmit data transmitted from the base station apparatus to the first communication apparatus,
wherein due to a first data transfer by the first data transfer unit from the first communication apparatus to the base station apparatus, in a second data transfer from the base station apparatus to the first communication apparatus performed in the second data transfer unit, the controller
selects a communication method different from a communication method used for the first data transfer, or
selects an identical communication method to a communication method used for the first data transfer in some cases, and
the second data transfer is performed using the selected communication method.

2. The control station apparatus according to claim 1,
wherein the second communicator further includes a third data transfer unit configured to communicate with a second communication apparatus and transmit data transmitted from the second communication apparatus to the first communication apparatus,
the controller, in a third data transfer from the second communication apparatus to the first communication apparatus performed in the third data transfer unit,
selects a communication method different from a communication method used for data transfer from the second communication apparatus to own device, or
selects an identical communication method to a communication method used for data transfer from the second communication apparatus to own device in some cases, and
the third data transfer is performed using the selected communication method.

3. The control station apparatus according to claim 1, further comprising:
a third data transfer unit configured to transmit data transmitted from the first communication apparatus to the first communication apparatus again,
wherein
the controller, in a third data transfer in which data transmitted from the first communication apparatus is transmitted to the first communication apparatus again, performed in the third data transfer unit,
selects a communication method different from a communication method used for data transfer from the first communication apparatus to own device, or
selects an identical communication method to a communication method used for data transfer from the first communication apparatus to own device in some cases, and
the third data transfer is performed using the selected communication method.

4. The control station apparatus according to claim 1,
wherein the first communicator includes at least two communication methods, and
the at least one communication method is capable of transmitting data to an external network.

5. The control station apparatus according to claim 1, further comprising:
a third communicator configured to communicate with another of the control station apparatus, and
a third data transfer unit configured to transmit data transmitted from the first communication apparatus to another of the control station apparatus.

6. The control station apparatus according to claim 5,
wherein the third data transfer unit transmits data transmitted from the base station apparatus to another of the control station apparatus.

7. A communication method included in a control station apparatus, the method at least comprising the steps of:
performing a first communication to communicate as a terminal with a base station apparatus,
performing a second communication to communicate with a first communication apparatus with at least two communication methods,
performing control to select one communication method from the at least two communication methods,
performing a first data transfer to transmit data transmitted from the first communication apparatus to the base station apparatus, and
performing a second data transfer to transmit data transmitted from the base station apparatus to the first communication apparatus,
wherein due to a first data transfer by the performing the first data transfer from the first communication apparatus to the base station apparatus, in a second data transfer from the base station apparatus to the first communication apparatus performed in the performing the second data transfer, the performing control
selects a communication method different from a communication method used for the first data transfer, or
selects an identical communication method to a communication method used for the first data transfer in some cases, and
performing the second data transfer using the selected communication method is included.

8. A communication system including a base station apparatus, a first communication apparatus and a control station apparatus, the control station apparatus at least comprising:
a first communicator configured to communicate as a terminal with the base station apparatus,
a second communicator configured to communicate with a first communication apparatus with at least two communication methods,
a controller configured to select one communication method from the at least two communication methods,
a first data transfer unit configured to transmit data transmitted from the first communication apparatus to the base station apparatus, and
a second data transfer unit configured to transmit data transmitted from the base station apparatus to the first communication apparatus,
wherein due to a first data transfer by the first data transfer unit from the first communication apparatus to the base station apparatus, in a second data transfer from the base station apparatus to the first communication apparatus performed in the second data transfer unit, the controller
selects a communication method different from a communication method used for the first data transfer, or
selects an identical communication method to a communication method used for the first data transfer in some cases, and
the second data transfer is performed using the selected communication method.
